(19) United States
(12) Patent Application Publication
(10) Pub. No.: US 2005/0226463 A1
(43) Pub. Date: Oct. 13, 2005

(54) Imaging data server and imaging data transmission system

(75) Inventors: Takuya Suzuki, Kawasaki (JP); Masashi Matsumoto, Kawasaki (JP); Takashi Kanasugi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/893,896

(22) Filed: Jul. 20, 2004

(30) Foreign Application Priority Data
Mar. 31, 2004 (JP) 2004-102546

(51) Int. Cl. G06K 9/00; H04N 7/00

(52) U.S. Cl. 382/103; 348/143

(57) ABSTRACT

The present invention relates to an imaging data server. The imaging data server acquires a plurality of types of imaging data pertaining to a plurality of objects of surveillance and transmits the acquired imaging data to a monitoring station over a network. The imaging data server comprises determination section for determining whether or not a change has arisen in the status of each of the objects of surveillance pertaining to a plurality of types of the imaging data; and a priority transmission section for transmitting, to the monitoring station, imaging data pertaining to an object of surveillance in which the status change is determined to have arisen by the determination section, with a higher priority than that utilized in the case of imaging data pertaining to an object of surveillance in which no status change is determined to have arisen.

### BACKGROUND OF THE INVENTION

1) Field of the Invention

The present invention relates to an imaging data server and an imaging data transmission system, which are suitable for use in remotely monitoring a surveillance image.

2) Description of the Related Art

An increasing number of crimes has recently led to demand for an imaging data transmission system intended for preventing occurrence of crimes on the streets and in shopping districts, in schools or other important facilities, or on the premises thereof. The imaging data transmission system takes these locations or facilities as objects of surveillance, and images of the locations or facilities are captured by a camera. The thus-captured images are monitored in real time by means of a monitor at a location remote from the object of surveillance. Meanwhile, steady progress has been made toward proliferation of broadband Internet service and development of a large-capacity intranet. Against such a backdrop, introduction of a visual monitoring system using an IP (Internet Protocol) is increasing.

FIG. 16 shows a general example configuration of an imaging data transmission system 100 which remotely monitors images by utilization of an IP transmission path. The system 100 shown in FIG. 16 comprises a monitored station 110 for transmitting images of an object of surveillance from a remote location; a monitoring station 120 which monitors the object transmitted from the monitored station 110; and an IP network 130 which connects the monitored station 110 with the monitoring station 120.

The monitored station 110 comprises, e.g., four cameras 101 through 104 for capturing images of a location which is an object of surveillance, a camera server 106, and a router 107. Of the cameras 101 to 104, the cameras 101 to 103 are fixed, and one (e.g., the camera 104) of the cameras is taken as a movable camera capable of movably controlling an imaging attitude by way of the camera server 106 in accordance with control data output from the monitoring station 120.

The camera server 106 has a function of converting video data captured by the cameras 101 to 104 into IP packets and transmitting the video data to the IP network 130; and a function of receiving the control data output from the monitoring station 120 by way of the IP network 130 and transmitting the thus-received control data to the cameras 101 to 104. The router 107 transmits the IP packets output from the camera server 106 to the IP network 130 and outputs to the camera server 106 the IP packets which have been transmitted over the IP network 130 and addressed to the camera server 106.

The monitoring station 120 is arranged to be able to receive the video data transmitted from the monitored station 110 over the IP network 130 and display the thus-received video data on a display or the like as a monitored image. Therefore, the monitoring station 120 comprises a terminal device 121 equipped with a display 121a, and a router 122 which transmits to the IP network 130 the IP packets output from the terminal device 121 and outputs to the terminal device 121 the IP packets output from the IP network 130.

As mentioned above, the monitoring station 120 can transmit the IP packet to the camera server 106 as control data, and the camera server 106 can control the operating state of the camera 104 upon receipt of the IP packet, as required. The monitoring station 120 can also be made to cover a plurality of monitored stations as the monitored station 110.

Since the image data usually have a large volume, the imaging data transmission system 100 usually transmits the imaging data after having compressed the same by means of an image compression technique. A transmission path serving as a network having a sufficient volume must be reserved beforehand at the time of design of the network so that a band necessary to transmit the data can be reserved.

Known techniques relevant to the present invention includes a technique described in Patent Document 1. Patent Document 1 describes a network system which comprises a motion picture server and a management device and enables efficient utilization of a network by means of storing only required images in the motion picture server. In the network system, in order to shorten a time from when motion picture data is acquired until the motion picture data is distributed to the plurality of clients, the motion picture server compresses and encodes the motion picture data output from the camera through use of an IP encoder without temporarily storing the data, to thus generate packets and enable multicasting operation. Further, the motion picture server collects and stores the motion picture data. The management device receives a distribution addressed to the motion picture server and executes distribution processing.

[Patent Document 1] Japanese Patent Laid-open 2001-245281

In the above-described common imaging data transmission system 100, even when images are compressed and transmitted by means of the image compression technique, a large-capacity transmission path is required when the user requires fine image quality due to monitoring circumstances or when there are a large number of monitored stations. Therefore, there is a necessity for reserving a network of considerable volume in advance. But, in real service, there are many situations which do not require simultaneous monitoring of a plurality of locations with fine images. Hence, there is a problem of difficulty in effectively utilizing the network band.

In the case of an object of surveillance which requires fine image quality when a change has arisen in situations of the object, even when images are compressed by the image compression technique and transmitted, real-time monitoring always requires a large-capacity transmission path. Hence, the technique described in Patent Document 1 also suffers the same problem as that encountered by the imaging data transmission system 100.

### SUMMARY OF THE INVENTION

The present invention has been conceived in light of the problems set forth, and provides an imaging data server and an imaging data transmission system which enable effective utilization of a band of a network while supplying video data in accordance with real operating condition, by means of forming video data to be transmitted to a network in conjunction with a change in the status of an object of surveillance.

To this end, the present invention provides an imaging data server which acquires a plurality of types of imaging data pertaining to a plurality of objects of surveillance and transmits the acquired imaging data to a monitoring station over a network, comprising: a determination section for determining whether or not a change has arisen in the status of each of the objects of surveillance pertaining to a plurality of types of the imaging data; and a priority transmission section for transmitting, to the monitoring station, imaging data pertaining to an object of surveillance in which the status change is determined to have arisen by the determination section, with a higher priority than that employed in the case of imaging data pertaining to an object of surveillance in which no status change is determined to have arisen.

The imaging data server may be constituted by further comprising: external sensors for detecting a change in the status of each of objects of surveillance, wherein the determination section has a sensor data determination section for determining whether or not the status change has arisen, on the basis of detection data output from the external sensors.

In the imaging data server, the determination section may be constituted by comprising a frame difference computation section for computing a difference in frames of imaging data acquired for a plurality of the respective objects of surveillance; and a frame difference determination section for determining whether or not the status change has arisen, on the basis of a result of computation of the frame difference computed by the frame difference computation section.

Moreover, in the imaging data server, the determination section may be constituted by comprising a transmission environment setting receiving section for receiving settings of a transmission environment pertaining to specific imaging data output from the monitoring station; and a priority requirement determination section which determines whether or not the status change has arisen, on the basis of the transmission environment settings received by the transmission environment setting receiving section.

The priority transmission section can be constituted by comprising an image quality control transmission section for transmitting imaging data pertaining to the object of surveillance in which the status change is determined to have arisen by the determination section, after having enhanced image quality of the imaging data.

The priority transmission section can be constituted by comprising a priority packet generation section for generating a packet imparted with priority processing data, from imaging data pertaining to the object of surveillance in which the status change is determined to have arisen by the determination section.

The priority transmission section can also be constituted by comprising a band reserving control section which performs control operation for securing a band of the network over which are transmitted imaging data pertaining to the object of surveillance in which the status change is determined to have arisen by the determination section.

The priority transmission section may be constituted by comprising an imaging data selection transmission section which stops transmission of imaging data pertaining to an object of surveillance in which no status change is determined to have arisen by the determination section and which transmits imaging data pertaining to an object of surveillance in which the status change is determined to have arisen by the determination section.

The imaging data server may further comprise an end control section for terminating the priority transmission of the priority transmission section.

In this case, the end control section may preferably comprise a clock section for clocking a time during which the priority transmission section performs the priority transmission; and a first control section for terminating the priority transmission performed by the priority transmission section when the clock section determines that the time during which the priority transmission is being performed has exceeded a predetermined time.

Alternatively, the end control section may be constituted by comprising a status recovery determination section for determining whether or not the change in the status of the object of surveillance in which the status change is determined to have arisen by the determination section has disappeared; and a second control section for terminating the priority transmission performed by the priority transmission section when the status recovery determination section has determined that the change in the status of the object of surveillance, in which the status change is determined to have arisen, has disappeared.

An imaging data transmission system of the present invention comprises: a plurality of imaging devices for capturing images of objects of surveillance; a monitoring station for receiving the images captured by the imaging devices for monitoring purpose; and an imaging data server which acquires the imaging data captured by the respective imaging devices and which transmits the acquired imaging data to the monitoring station over a network, wherein the imaging data server comprises a determination section which determines whether or not a change has arisen in the status of each of objects of surveillance pertaining to the imaging data captured by the respective imaging devices; and a priority transmission section for transmitting, to the monitoring station, imaging data pertaining to an object of surveillance in which the status change is determined to have arisen by the determination section, with a higher priority than that employed in the case of imaging data pertaining to an object of surveillance in which no status change is determined to have arisen.

In the imaging data transmission system, the monitoring station may have a close-up display control section which performs control operation for displaying the imaging data in a close-up manner upon receipt of the imaging data which pertain to the object of surveillance in which the status change is determined to have arisen by the determination section and have been transmitted from the imaging data server in a prioritized manner.

As mentioned above, according to the present invention, the imaging data server can transmit to the monitoring station imaging data pertaining to an object of surveillance—in which the status change is determined to have arisen by the determination section—by means of the priority transmission section, with a higher priority than that employed in the case of imaging data pertaining to an object of surveillance in which no status change is determined to have arisen. Hence, there is an advantage of the ability to form video data to be transmitted to the network in conjunction with a change in the status of the object of surveillance while implementing real-time remote surveillance of the object, as well as the ability to reliably transmit the video data pertaining to the important object of surveillance in which the status change is determined to have arisen while supplying video data conforming to an operating condition and effectively utilizing a band of the network.

### BRIEF DESCRIPTION OF THE DRAWINGS

FIG. 1 is a block diagram showing an imaging data transmission system according to an embodiment of the present invention;

FIG. 2 is a block diagram showing the principal configuration of a camera server of the embodiment;

FIG. 3 is a view showing the principal configuration of the camera server of the embodiment with attention focused on a configuration for implementing a first modification for detecting a change in status (event);

FIG. 4 is a view showing the principal configuration of the camera server of the embodiment with attention focused on a configuration for implementing a second modification for detecting a change in status (event);

FIG. 5 is a view showing the principal configuration of the camera server of the embodiment with attention focused on a configuration for implementing a third modification for detecting a change in status (event);

FIG. 6 is a view showing transmission setting pattern memory of the embodiment;

FIG. 7 is a signal sequence diagram for describing operation of the imaging data transmission system of the embodiment;

FIG. 8 is a signal sequence diagram for describing operation of the imaging data transmission system of the embodiment;

FIGS. 9A, 9B are signal sequence diagrams for describing operation of the imaging data transmission system of the embodiment;

FIG. 10 is a view showing an L2 switch provided on a router of a monitored station of the embodiment;

FIG. 11 is a view showing a network configuration presumed for describing operation of the imaging data transmission system of the embodiment;

FIG. 12 is a signal sequence diagram for describing operation of the imaging data transmission system of the embodiment;

FIGS. 13A, 13B are views for describing a display modification of the monitoring station of the embodiment;

FIG. 14 is a flowchart for describing operation of the imaging data transmission system of the embodiment;

FIG. 15 is a flowchart for describing operation of the imaging data transmission system of the embodiment; and

FIG. 16 is a view showing a conventional example imaging data transmission system.

### DESCRIPTION OF THE PREFERRED EMBODIMENT

An embodiment of the present invention will now be described by reference to the drawings.

[A] Description of the Entire Configuration of an Imaging Data Transmission System According to an Embodiment

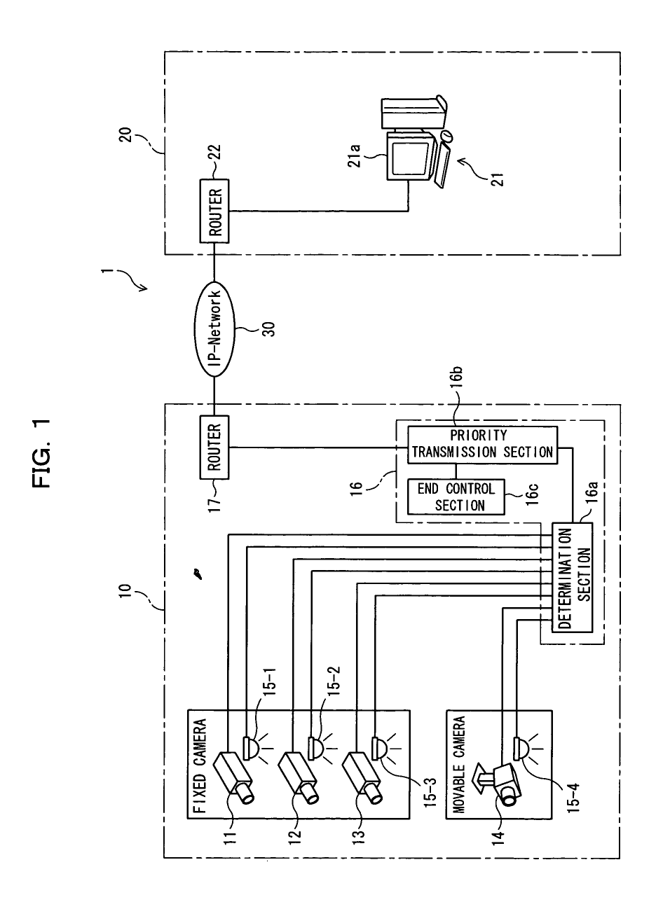

FIG. 1 is a block diagram showing an imaging data transmission system 1 according to an embodiment of the present invention. The imaging data transmission system 1 shown in FIG. 1 can also be applied to a system intended for preventing occurrence of crime on the streets and in shopping districts, in schools or other important facilities, or on the premises thereof, wherein the imaging data transmission system takes these locations or facilities as objects of surveillance; wherein images of the locations or facilities are captured by a camera; and wherein the thus-captured images are monitored by means of a monitor at a place remote from the object of surveillance.

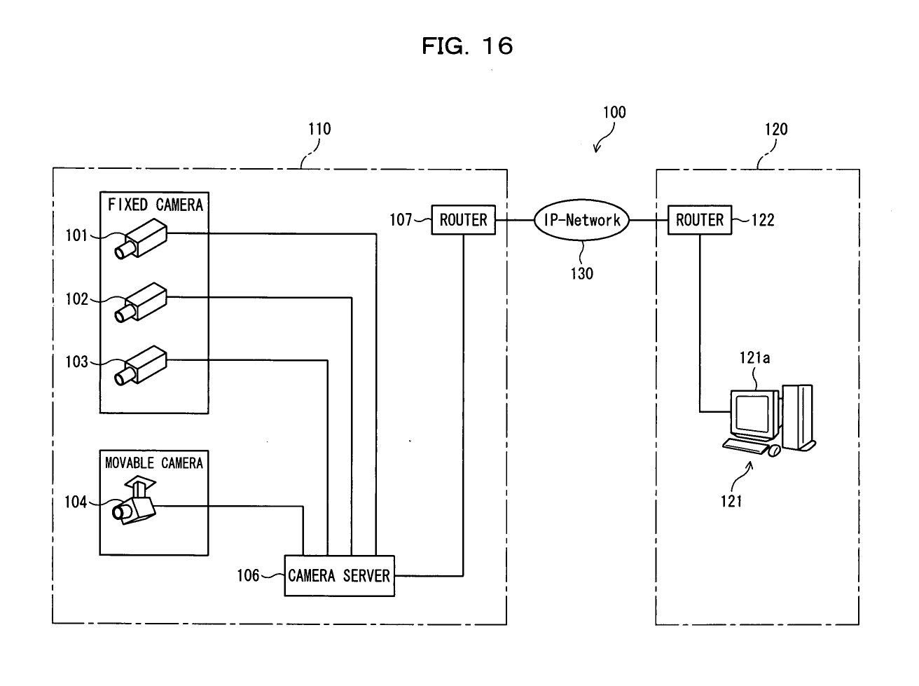

As in the case of the conventional imaging data transmission system shown in FIG. 16, the imaging data transmission system 1 shown in FIG. 1 comprises a monitored station 10 for transmitting images of an object of surveillance from a remote location; a monitoring-station 20 which monitors the object transmitted from the monitored station 10; and an IP network 30 which connects the monitored station 10 with the monitoring station 20.

For instance, when an unmanned communications machinery room is taken as the monitored station 10, objects of surveillance include an instrument panel or lamps showing the operating status of the communications machinery as well as the states of persons who enter the machinery room. When such an unmanned facility, or the like, is taken as the monitored station 10, the monitoring station 20 disposed at a remote location can effect monitoring with an operator by means of a representation on a display over the IP network 30.

The monitored station 10 comprises a plurality of imaging devices 11 to 14 which each photograph images of the object; a camera server 16 (an imaging data server) which acquires the imaging data captured by the respective imaging devices 11 to 14 and transmits the thus-captured imaging data to the monitoring station 20 by way of the IP network 30; and a router 17 analogous to that (see reference numeral 107) shown in FIG. 16. The imaging devices 11 to 14 can be embodied by, e.g., a motion picture camera capable of capturing motion pictures. In addition, the imaging devices 11 to 14 can also be embodied by a movable camera capable of changing its attitude in accordance with control data output from the monitoring station 20. In the embodiment, the imaging devices 11 to 13 are embodied by a fixed camera, and the imaging device 14 is embodied by a movable camera.

The monitoring station 20 receives, for monitoring purpose, images which have been captured by the imaging devices 11 to 14 and transmitted from the camera server 16 over the IP network 30. The monitoring station 20 comprises a terminal device 21 and a router 22, which are analogous to those shown in FIG. 16 (see reference numerals 121, 122).

As in the case of the monitoring station shown in FIG. 16, the monitoring station 20 is configured to monitor a plurality of monitoring stations analogous to the monitored station 10. One monitoring station 20 is arranged so as to be able to monitor a plurality of the monitored stations 10 in a concentrated manner. For convenience of explanation, one monitored station 10 is illustrated in the following descriptions.

The camera server 16 has a characteristic function of the present invention, and attention is focused on that function. Specifically, the camera server 16 comprises a determination section 16a for determining occurrence/absence of a change (event) in the status of the object relating to the imaging data captured by the respective imaging devices 11 to 14; a priority transmission section 16b for transmitting, to the monitoring station 20, the imaging data pertaining to the object for which the determination section 16a has determined occurrence of a status change with a higher priority than that of the imaging data pertaining to the object whose status change has determined not to have arisen; and an end control section 16c which terminates the priority transmission performed by the priority transmission section 16b.

In the camera server 16, the determination section 16a determines a change in the status of the object (hereinafter often called a “status change”), and the priority transmission section 16b dynamically selects utilization of a band of the network 30 in accordance with the result of determination, thereby enabling effective utilization of narrow bandwidths.

Specifically, in normal times where a status change is not detected, the IP network 30 utilizes a comparatively-narrow band of the IP network 30, and all the video data captured by the imaging devices 11 to 14 are merged and transmitted. When the status change has been detected, a comparatively-wide band in the IP network 30 is utilized, and the video data-which are output from the respective imaging devices 11 to 14 and pertain to the object whose status change has been detected an be transmitted with high priority.

FIG. 1 shows external sensors 15-1 to 15-4 which are provided in the vicinity of the respective imaging devices 11 to 14 for detecting a status change to be determined by the determination section 16a of the first embodiment. The external sensors 15-1 to 15-4 can obtain a detection output pertaining to a change in the statuses of the objects whose images are captured by the respective imaging devices 11 to 14 (e.g., a sound detection output, a detection output pertaining to opening and closing of a door which is an object of surveillance, or the like).

The imaging devices 11 to 14 may capture different objects of surveillance, separately. Alternatively, the imaging devices 11 to 14 may capture a single object of surveillance from different angles. For instance, the imaging devices 11 to 14 can capture images of a plurality of locations in a shopping district as objects of surveillance. Alternatively, when images of the border of a property are captured as objects of surveillance, a single location can also be captured by means of the imaging devices 11 to 14 disposed at a plurality of positions.

The principal configuration of the camera server 16 will now be described.

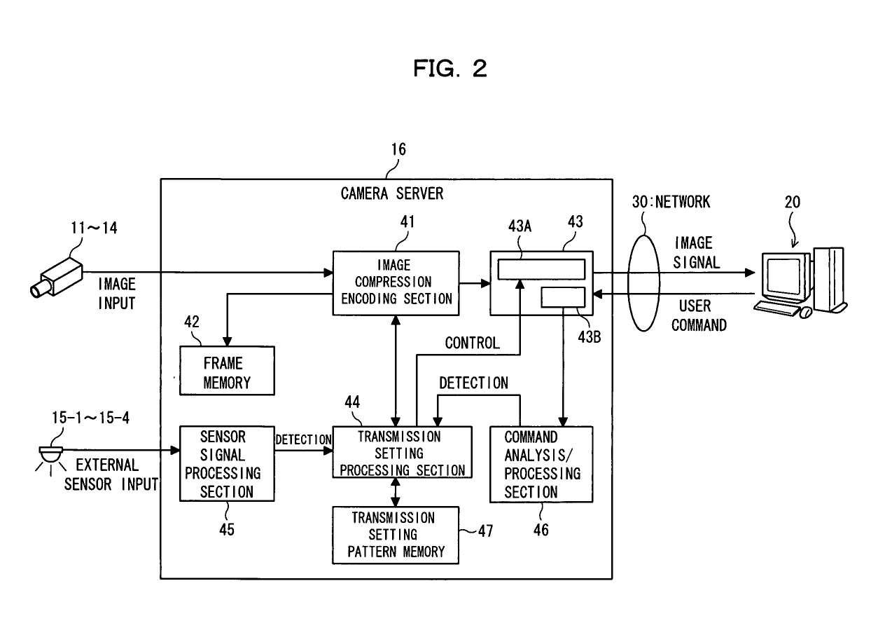

FIG. 2 is a block diagram showing the principal configuration of the camera server 16 of the embodiment. The camera server 16 shown in FIG. 2 sequentially transmits the motion picture data captured by the imaging devices 11 to 14 as stationary imaging data merged on a per-frame basis and in an IP packet format. The camera server 16 comprises an image compression encoding section 41, frame memory 42, a network processing section 43, a transmission setting processing section 44, a sensor signal processing section 45, a command analysis/processing section 46, and transmission setting pattern memory 47.

The image compression encoding section 41 generates stationary frames from the video data (e.g., motion picture data) captured by the imaging devices 11 to 14 and encodes the stationary frames in, e.g., an MJPEG (Motion Joint Photographic Experts Group) format. The frame memory 42 temporarily stores the stationary frames generated by the image compression encoding section 41.

The network processing section 43 effects interface processing (network processing) of a signal format between the camera server 16 and the IP network 30. The network processing section 43 comprises a network transmission processing section 43A and a network receiving processing section 43B.

The network transmission processing section 43A receives the video data compressed and encoded by the image compression encoding section 41 and processes the video data into data of packet format. Further, the network transmission processing section 43A outputs the packet data to the router 17 by means of affixing header information to the packet data. The network receiving processing section 43B receives IP packets (into which control information, such as attitude control information, about the imaging devices 11 to 14) output from the monitoring station 20 over the IP network 30 and terminates the IP packets.

The transmission setting processing section 44 determines whether or not a change has arisen in the statuses of the objects pertaining to the video data captured by the imaging devices 11 to 14. On the basis of the result of determination, the transmission setting processing section 44 makes settings for priority transmission. Here, a modification for rendering a determination pertaining to absence or presence of a status change includes the following three modifications. Moreover, the modification of priority transmission also includes a modification for setting the image compression encoding section 41 and a modification for setting the network processing section 43.

Therefore, the transmission setting processing section 44 has the function of the determination section 16a shown in FIG. 1 and functions as the priority transmission section 16b shown in FIG. 1 by means of the image compression encoding section 41 and the network processing section 43. The transmission setting processing section 44 also has the function of the end control section 16c shown in FIG. 1, as will be described later.

In order to cause the transmission setting processing section 44 serving as the determination section 16a to detect a status change in the first modification, the sensor signal processing section 45 subjects, to interface signal processing, signals (contacts or serial signals) output from the external sensors 15-1 to 15-4 provided in the vicinity of the respective imaging devices 11 to 14. On the basis of the result of processing of these signals, the transmission setting processing section 44 can determine the presence or absence of a change in the statuses of the objects pertaining to the video data captured by the respective imaging devices 11 to 14.

The command analysis/processing section 46 receives, from the network processing section 43, the control data transmitted from the monitoring station 20 over the IP network 30, analyzes descriptions of the control data as command data, and performs processing pursuant to the descriptions of the data. In the second modification of a determination as to presence/absence of a status change rendered by the determination section 16a, which will be described later, a determination is made as to whether or not a change has arisen in the statuses, in accordance with a command output from the command analysis/processing section 46.

The transmission setting pattern memory 47 stores setting information to be used for effecting priority transmission, by means of files or the like through setting of the image compression encoding section 41. By reference to the data of the transmission setting pattern memory 47, the transmission setting processing section 44 can set the transmission setting of the image compression encoding section 41 to the first modification for priority transmission to be described later.

By means of the foregoing configuration, the imaging data transmission system 1 of the embodiment usually transmits the images captured by all the imaging devices 11 to 14 in a narrow band. Only when some type of a status change has occurred in the monitored station 10, corresponding images of the imaging devices 11 to 14 are transmitted in a broadband with a higher priority than are other images.

Specifically, when the transmission setting processing section 44 has detected a change in the statuses of the objects whose images are captured by the imaging devices 11 to 14, the transmission setting processing section 44 of the camera server 16 performs processing for setting the image compression encoding section 41 and the network processing section 43 such that the transmission setting environment complying with the status change is achieved by reference to the transmission setting pattern memory 47.

As a result, the camera server 16 can transmit the images—which pertain to the objects whose status changes have been detected and which are captured by the imaging devices 11 to 14—to the monitoring station 20 over the IP network 30 in a prioritized manner.

The images that have been transmitted from the camera server 16 with higher priority can be displayed in an enlarged manner on the terminal device 21 of the monitoring station 20 through the display 21a.

After having determined that a necessity for priority transmission has been obviated, the end control section 16c provided in the transmission setting processing section 44 resets, to normal transmission settings (i.e., settings in which the images captured by all the imaging devices 11 to 14 are transmitted in a narrow band), the operation modification in which the images—which are captured by the imaging devices 11 to 14 and relate to the location where the status change has been detected—are transmitted in a prioritized manner.

[B-1-1] Description of the First Modification of Detecting a Status Change By the Detection Section

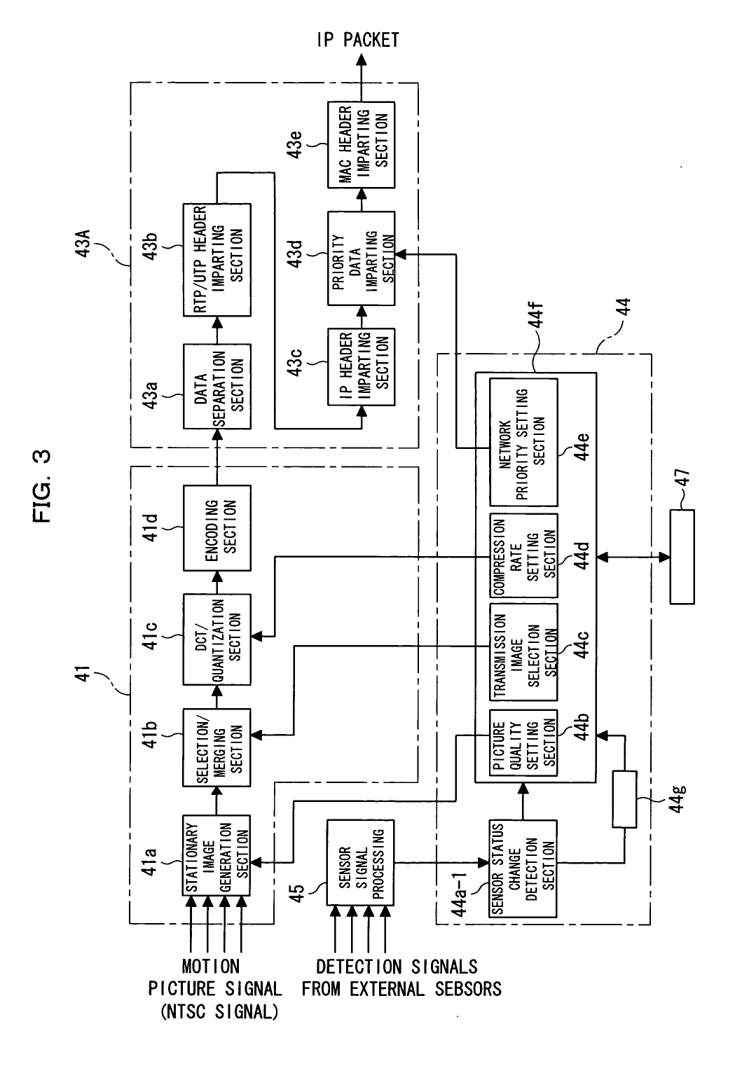

FIG. 3 is a view showing the principal configuration of the image compression encoding section 41, that of the network processing section 43, and that of the transmission setting processing section 44, all belonging to the camera server 16, with attention focused on a configuration for implementing the first modification for detecting a change in status (event).

As shown in FIG. 3, the image compression encoding section 41 comprises a stationary image generation section 41a, a selection/merging section 41b, a DCT (Discrete Cosine Transform)/quantization section 41c, and an encoding section 41d. The image compression encoding section 41 merges the video data which are output from the imaging devices 11 to 14 and which are input in the form of NTSC (National Television Standards Committee) signals, thereby compressing and encoding the thus-merged signals.

The network transmission processing section 43A of the network processing section 43 comprises a data separation section 43a, an RTP (Real-time Transport Protocol)/UTP (User Datagram Protocol) header imparting section 43b, an IP header imparting section 43c, a priority information imparting section 43d, and a MAC header imparting section 43e. The video data that have been compressed and encoded by the image compression encoding section 41 are converted into data of an IP packet format, and the thus-converted data are sent to the IP network 30 by way of the router 17.

The transmission setting processing section 44 implementing the first modification for detecting a status change has a sensor status change detection section 44a-1. Upon receipt, by way of the sensor signal processing section 45, of detection signals output from the external sensors 15-1 to 15-4, which are provided in the vicinity of the respective imaging devices 11 to 14, the sensor status change detection section 44a-1 determines whether or not a change has arisen in the status of any of the objects whose images are captured by the respective imaging devices 11 to 14, in accordance with the detection signals.

For instance, when the external sensors 15-1 to 15-4 are constituted of door open/close sensors for detecting opening and closing of a door by way of which persons enter and exit a room (e.g., an unmanned communications machinery room) which is an object of surveillance, the sensor status change detection section 44a-1 of the transmission setting processing section 44 is arranged to determine occurrence of a status change when the closed door is opened. Alternatively, when the sensors 15-1 to 15-4 are formed to detect an approach of a person, each of the sensors 15-1 to 15-4 determines occurrence of a status change when a person has approached.

The transmission setting processing section 44 shown in FIG. 3 is constituted of a priority setting section 44f and an end control section 44g along with the sensor status change detection section 44a-1.

When the sensor status change detection section 44a-1 has determined that a change has arisen in the status of the object monitored by any of the imaging devices 11 to 14, the sensor status change detection section 44a- 1 is arranged to send a report to this effect to the priority setting section 44f. As a result, the priority setting section 44f performs processing for setting the image compression encoding section 41 and the network processing section 43 to transmit in a prioritized manner the images captured by the imaging devices 11 to 14.

In other words, the sensor status change detection section 44a-1 of the transmission setting processing section 44 constitutes a sensor data determination section (the determination section 16a shown in FIG. 1) which determines occurrence/nonoccurrence of a status change on the basis of the detection data output from the external sensors 15-1 to 15-4 in cooperation with the sensor signal processing section 45. Alternatively, the image compression encoding section 41 and the network processing section 43 implement the function of the priority transmission section 16b (see FIG. 1) in cooperation with the priority setting processing section 44f of the transmission setting processing section 44.

The priority setting section 44f comprises an image quality setting section 44b for setting the stationary image generation section 41a of the image compression encoding section 41; a transmission image selection section 44c for setting the selection/merging section 41b; a compression rate setting section 44d for setting the DCT quantization section 41c, and a network priority setting section 44e for setting the priority data imparting section 43d of the network transmission processing section 43A constituting the network processing section 43. Operations of the respective functional sections will be described in detail at the time of description of the respective modifications for transmitting packets in a prioritized manner.

The end control section 44g of the transmission setting processing section 44 is for terminating priority transmission which is performed as a result of cooperation among the image compression encoding section 41, the network processing section 43, and the priority setting section 44f. The end control section 44g corresponds to the end control section 16c shown in FIG. 1. Operation of the end control section 44g will be described in detail at the time of description of the respective modifications for ending priority transmission.

[B-1-2] Description of the Second Modification of Detecting a Status Change by the Detection Section

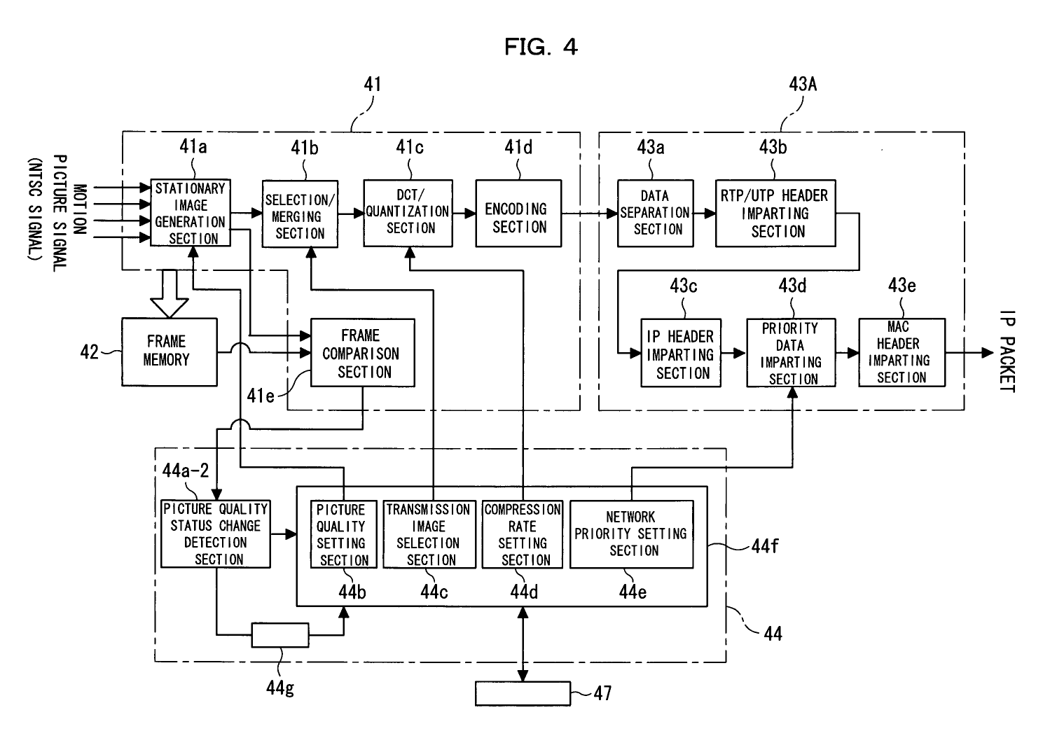

FIG. 4 is a view showing the principal configuration of the image compression encoding section 41, that of the network processing section 43, and that of the transmission setting processing section 44, all belonging to the camera server 16, with attention focused on a configuration for implementing the second modification for detecting a change in status (event).

The camera server shown in FIG. 4 differs from that shown in FIG. 3 in that a status change is detected by means of the camera server being provided with frame memory 42, the image compression encoding section 41 being provided with a frame comparison section 41e, and the transmission setting processing section 44 being provided with an image status change detection section 44a-2. In FIG. 4, reference numerals identical with those shown in FIG. 3 denote substantially the same portions.

The frame memory 42 stores stationary images which are sequentially produced by the stationary image generation section 41a of the image compression encoding section 41. The frame comparison section 41e computes, as a frame difference computation section, a difference between a stationary image produced by the stationary image generation section 41a and an immediately-preceding stationary image stored in the frame memory 42 and compares the immediately-preceding frame of the monitored image with the latest frame of the monitored image.

The image status change detection section 44a-2 is provided in place of the sensor status change detection section 44a-1 of the transmission setting processing section 44 shown in FIG. 3. The image status change detection section 44a-2 determines whether or not a difference between the frames computed by the frame comparison section 41e exceeds a predetermined threshold value. When the difference exceeds the threshold value, a change in an image (a status change) is determined to have arisen, and the priority setting section 44f can be informed of occurrence of the change.

In other words, the image status change detection section 44a-2 has the function of a frame difference determination section for determining whether or not a change has arisen in the status of an image on the basis of a result of computation of the difference output from the frame comparison section 41e.

As a result, when having determined that a change has arisen in the images of the object captured by the imaging devices 11 to 14 (i.e., when a status change has arisen), the image status change detection section 44a-2 provides the priority setting section 44f with a report to this effect. In order to send the images captured by the imaging devices 11 to 14 in a prioritized manner, the priority setting section 44f can perform processing for setting the image compression encoding section 41 and the network processing section 43.

[B-1-3]

Description of the Third Modification of Detecting a Status Change By the Detection Section

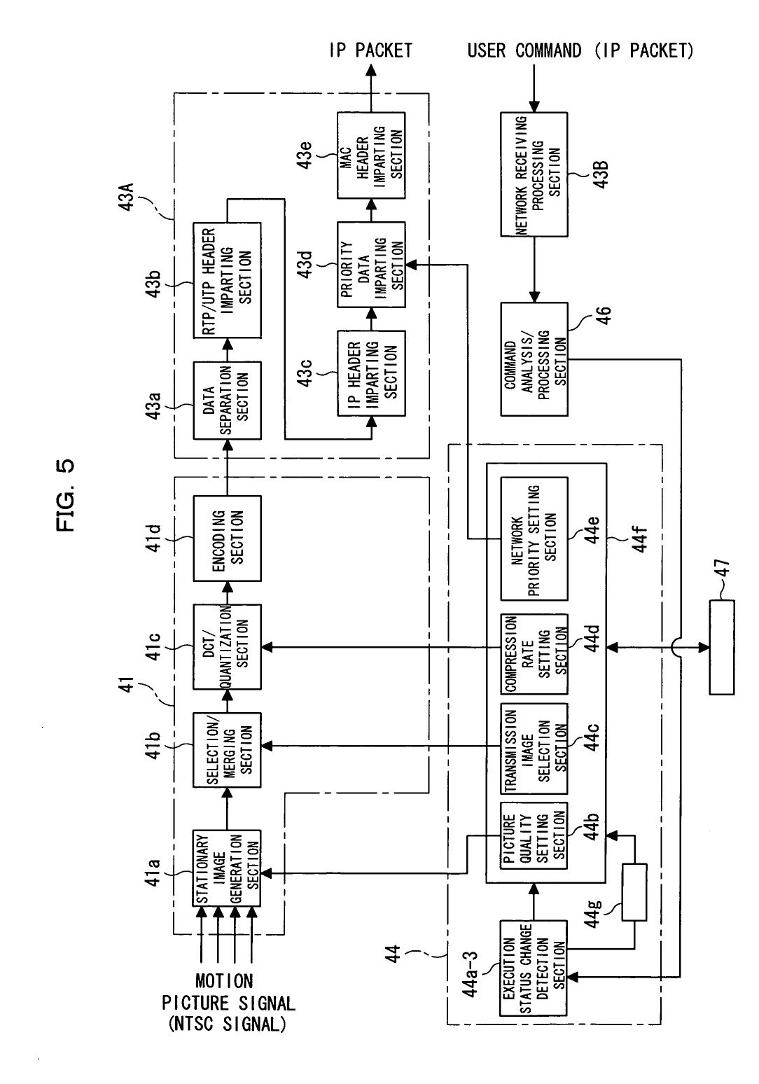

FIG. 5 is a view showing the principal configuration of the image compression encoding section 41, that of the network processing section 43, and that of the transmission setting processing section 44, all belonging to the camera server 16, with attention focused on a configuration for implementing the third modification for detecting a change in status (event).

The camera server shown in FIG. 5 differs in configuration from the camera servers in connection with the first and second modifications (see FIGS. 3 and 4) in that a status change is detected by a network receiving processing section 43B of the network processing section 43 and by the command analysis/processing section 46 and an execution status change detection section 44a-3 of the transmission setting processing section 44. In FIG. 5, reference numerals identical with those shown in FIGS. 3 and 4 denote substantially the same portions.

The command analysis/processing section 46 receives the command data addressed to the monitored station 10 from the monitoring station 20 by way of the network receiving processing section 43B and analyzes and processes details of the command. When the command is a command for requesting a change in the transmission settings of the image compression encoding section 41 and those of the network processing section 43; particularly, a change in a command for instructing a specific one of the imaging devices 11 to 14 to transmit imaging data, the command analysis/processing section 46 is designed to send a report to this effect to the execution status change detection section 44a-3. Put another way, the command analysis/processing section 46 acts as a transmission environment setting receiving section for receiving, from the monitoring station 20, settings of a transmission environment pertaining to the specific imaging data.

The execution status change detection section 44a-3 is provided in lieu of the sensor status change detection section 44a-1 (or the image status change detection section 44a-2) of the transmission setting processing section 44 shown in FIG. 3 (or FIG. 4). When receiving, from the command analysis/processing section 46, a command receipt report for carrying out the foregoing instruction, the execution status change detection section 44a-3 determines that the change has arisen and can send a report to this effect to the priority setting section 44f. In short, the execution status change detection section 44a-3 acts as a priority request determination section for determining whether or not a status change has arisen, on the basis of the transmission environment settings received by the command analysis/processing section 46.

As a result, when the execution status change detection section 44a-3 has determined that there is a command for changing settings of the respective imaging devices 11 to 14 relating to the environment for transmission of the images of the object of surveillance (i.e., the status change has arisen), the execution status change detection section 44a-3 sends a report to this effect to the priority setting section 44f. In order to transmit the images captured by the imaging devices 11 to 14 in a prioritized manner, the priority setting section 44f can perform processing for setting the image compression encoding section 41 and the network processing section 43.

[B-2] Description of a Modification of an Embodiment of Prioritized Packet Transmission By the Priority Transmission Section

When the transmission setting processing section 44 has determined that the status change has arisen as described in connection with the first through third modifications, the priority setting section 44f shown in FIGS. 3 through 5 is provided with a report about the result of determination, and the image quality setting section 44b can make a setting for increasing the resolution of the images of the imaging devices 11 to 14 to be transmitted with a high priority.

The stationary image generation section 41a of the image compression encoding section 41 is for generating a stationary frame from each of the video signals (NTSC signals) output from the imaging devices 11 to 14 every predetermined time intervals. The image quality setting section 44b of the priority setting section 44f can set an interval between the frames and the resolution of the frames.

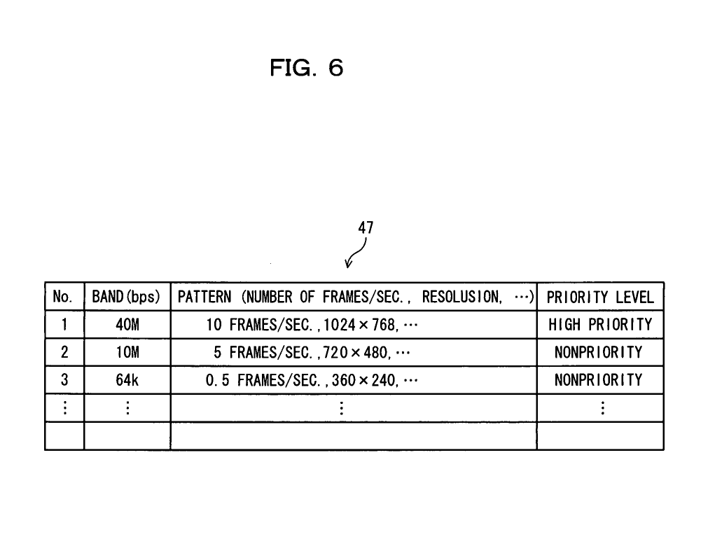

As shown in, e.g., FIG. 6, the transmission setting pattern memory 47 stores a plurality of types of generation patterns concerning stationary frames generated by the stationary image generation section 41a. As shown in FIG. 6, the transmission setting pattern memory 47 can set a resolution pattern of a transmission frame in accordance with the priority.

In order to transmit the video data in which occurrence of the status change is detected to the network-in a prioritized manner, the stationary image generation section 41a can switch the image quality of a stationary image to be generated (i.e., the number of frames generated per unit time or the resolution of a stationary image).

Specifically, when an attempt is made to send the video data with a high priority, the image quality setting section 44b of the priority setting section 44f extracts corresponding resolution setting data of a high priority level (e.g., data pertaining to a No. 1 pattern file shown in FIG. 6) from the transmission setting pattern memory 47. On the basis of the thus-extracted resolution setting data, there can be performed processing for setting the image quality of the stationary image frame generated by the stationary image generation section 41a. In this case, the high-priority pattern is set such that high image quality is achieved by appropriate setting of the number of frames per unit time and a resolution.

Consequently, by means of synergistic functioning of the stationary image generation section 41a, the image quality setting section 44b, and the transmission setting pattern memory 47, there is constituted an image quality control transmission section which transmits imaging data pertaining to an object in which a status change is determined to have arisen by any of the sensor status change detection section 44a-1, the image status change detection section 44a-2, and the execution status change detection section 44a-3 (these sections will be often collectively referred to as a “status change detection section”) after having enhanced the image quality of the imaging data.

The selection/merging section 41b of the image compression encoding section 41 selects a necessary stationary image frame from the stationary image frames which originate from the respective imaging devices 11 to 14 and are generated by the stationary generation section 41a, merges the thus-selected stationary frames into a single frame, and outputs the frame every predetermined time intervals. Stationary frames required to merge frames in the selection/merging section 41b are selected and set by the transmission image selection section 44c.

Specifically, in order to send the video data, in which occurrence of a status changes is detected, to the network 30 in a prioritized manner, the transmission image selection section 44c can select the video data to be sent to the IP network 30 from among the video data captured by the imaging devices 11 to 14 so that only the video data pertaining to detection of status change can be transmitted.

[B-2-1] More specifically, in a state in which none of the status change detection sections 44a-1 to 44a-3 has detected a change, there are merged stationary image frames originating from the imaging devices 11 to 14 among the stationary image frames generated by the stationary image generation section 41a. When any of the status change detection sections 44a-1 to 44a-3 has detected a status change, the stationary image frames output from only the image device among the imaging devices 11 to 14 that has detected a status change are selected and output to the DCT quantization section 41c. As a result, transmission of camera images other than the images corresponding to the status change is stopped, thereby enabling transmission to the IP network 30 of only the images in which occurrence of a status change is detected.

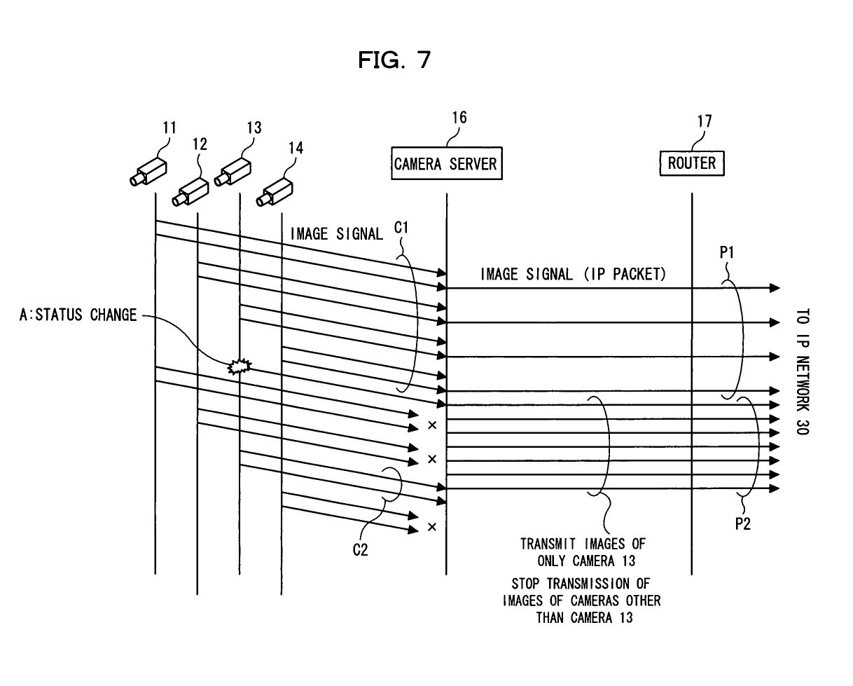

For instance, as can be seen from a signal sequence diagram shown in FIG. 7, all the images pertaining to video data Cl output from the imaging devices 11 to 14 are merged in normal times where no status change arises, and the thus-merged images are transmitted to the IP network 30 as IP packets P1 by way of the network processing section 43. However, when any of the status change detection sections 44a-1 to 44a-3 has detected a change in the status of the object monitored by the imaging device 13, a stationary image frame is formed from only video data C2 output from the imaging device 13. The thus-generated stationary image frame is transmitted to the IP network 30 as IP packets P2. At this time, transmission of the images output from the imaging devices 11, 12, and 14 exclusive of the imaging device 13 is stopped.

Consequently, the foregoing transmission image selection section 44c and the selection/merging section 41b constitute an imaging data selection transmission section which transmits the imaging data pertaining to the object of surveillance in which a status change is determined to have arisen by any of the status change detection sections 44a-1 to 44a-3, by means of suspending transmission of the imaging data pertaining to the object of surveillance in which a status change is determined not to have arisen by any of the status change detection sections 44a-1 to 44a-3.

The DCT/quantization section 41c subjects, to discrete cosine conversion and quantization processing (compression processing), the stationary image frame output from the selection/merging section 41b every predetermined time intervals. The compression rate setting section 44d of the priority setting section 44f can set a compression rate for the compression processing performed by the DCT/quantization section 41c.

[B-2-2] In order to transmit to the network in a prioritized manner the video data that have detected occurrence of a status change, the priority data imparting section 43d of the network transmission processing section 43A can impart an MPLS (Multi-protocol Label Switching) label for RSVP-TE (Resource Reservation Protocol Traffic Engineering: RFC3209) to, as priority data, packets before transmission given an IP header by the IP header imparting section 43c. A band is reserved for the IP packets given the MPLS label along a predetermined route in the IP network 30.

The network priority setting section 44e of the priority setting section 44f sets the priority data imparting section 43d. By means of the setting operation, packets output from the IP header imparting section 43c can be additionally provided with a label for requesting reservation of a band on the predetermined route in the IP network 30.

As a result, the router 17 serving as an entrance of the MPLS network receives the packets given the label for requesting reservation of the band, thereby reserving the corresponding band. When the band has been reserved, a response indicating completion of reservation of the band is sent to the camera server 16. When the network processing section 43B has received the response from the router 17 indicating completion of reservation of the band, the camera server 16 can transmit the video data to the monitoring section 20 without fail by way of the route in which the band is reserved, by means of the label setting operation performed by the network priority setting section 44e.

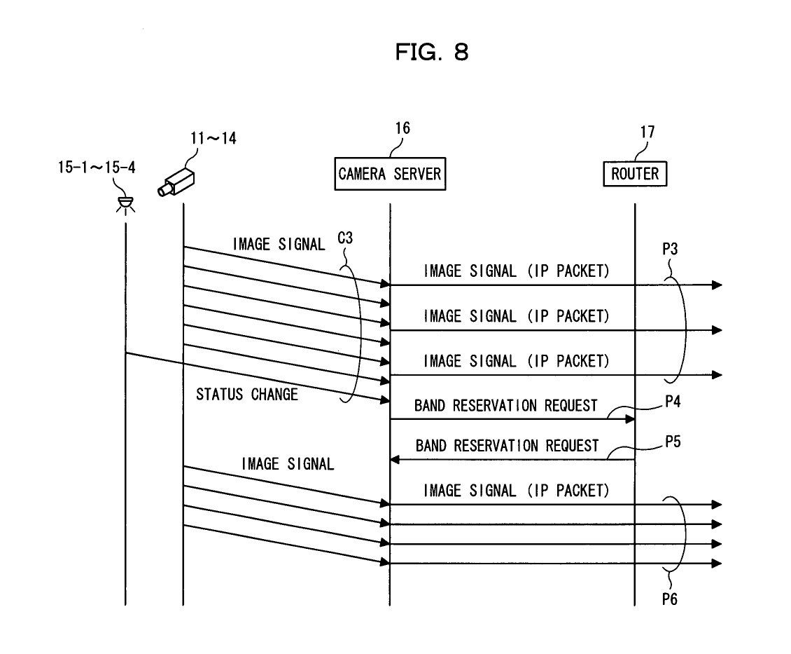

For instance, as can be seen from the signal sequence diagram shown in FIG. 8, the video data C3 output from the imaging devices 11 to 14 are transmitted, in normal times where no status change arises, to the IP network 30 as the IP packets P3 by way of the network processing section 43. At this time, when any one of the status change detection sections 44a-1 to 44a-3 (the sensor status change detection section 44a-1 for detecting a status change in accordance with the signals output from the external sensors 15-1 to 15-4 shown in FIG. 8) has detected a change in the status of the object monitored by the imaging device 13, the network priority setting section 44e controls the priority data imparting section 43c, thereby imparting an MPLS label requesting reservation of a band to the IP packets to be transmitted to the IP network 30 over the router 17 (see P4 in FIG. 8).

In response to the request for reserving a band, the router 17 performs processing for reserving a band. When the band is reserved, a message to this effect is sent as a reply to the camera server 16 (see P5 in FIG. 8). Upon receipt of the response indicating completion of reservation of the band from the router 17, the priority data imparting section 43d imparts the IP packets P6 output from the camera server 16 with, as priority data, a label indicating a packet to be transferred over a route whose band has been reserved. As a result, the IP packets P6 output from the camera server 6 are transferred along the route, whose band is ensured, in the IP network 30.

Consequently, the network priority setting section 44e and the priority data imparting section 43d constitute a band reserving control section. The band reserving control section performs control operation for reserving a band of the network 30 for transmitting imaging data pertaining to an object of surveillance in which a status change is determined to have arisen by any of the status change detection sections 44a-1 to 44a-3.

[B-2-3] As a modification of the embodiment, in order to send to the network 30 in a prioritized manner the video data in which the status change has been detected, the priority data imparting section 43d of the network transmission processing section 43A may impart a priority data bit to each of the packets before transmission imparted with the IP header by the IP header imparting section 43c.

Specifically, the priority data imparting section 43d imparts a priority bit to a Virtual LAN Tag priority field or a ToS (Type of Service) field under control of the network priority setting section 44e.

Here, Virtual LAN Tag priority corresponds to a 3-bit user priority (priority description) field included in a VLAN (virtual LAN) tag header of IEEE (Institute of Electrical and Electronic Engineers) 802.1Q and is standardized by IEEE802.1p. Here, “Type of Service” means an 8-bit field in an IP header where packet priority is to be described.

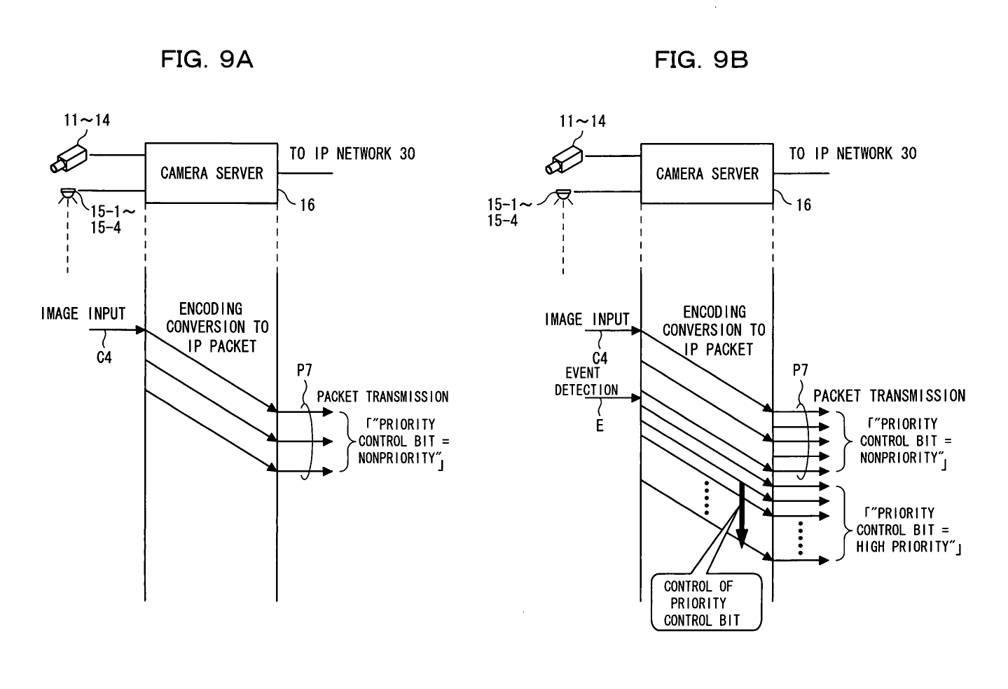

For instance, as can be seen from a sequence drawing shown in FIG. 9A, video data C4 output from the imaging devices 11 to 14 are delivered to the IP network 30 as IP packets 7, in normal times where no status change arises, by way of the image compression encoding section 41 and the network processing section 43. At this time, details of the priority data bit imparted to the IP packets P7 by the priority data imparting section 43d indicate “non-priority.”

As can be seen from the signal sequence drawing shown in FIG. 9B, when any of the status change detection sections 44a-1 to 44a-3 (e.g., the status change detection section 44a-1 in FIG. 9B) detects a status change (event) E in the object monitored by the imaging device 13, the network priority setting section 44e of the priority setting section 44f controls the priority data imparting section 43d, thereby imparting a high priority to the contents of the priority data bit to be imparted to the IP packets P8 which are transmitted to the IP network 30 by way of the router 17.

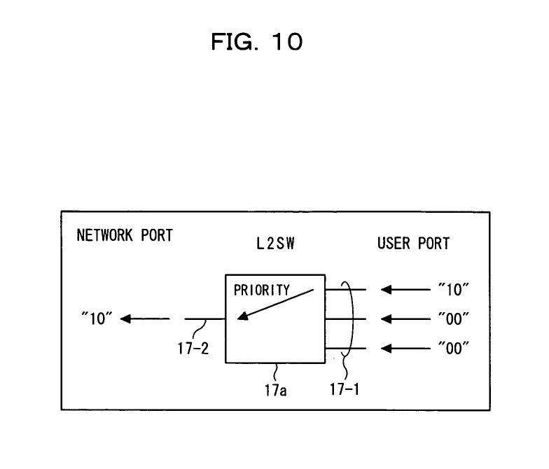

As shown in FIG. 10, the router 17 can be provided with an L2 (Layer-2) switch 17a for switching the IP packets output from the camera server 16 in accordance with the contents of the foregoing priority data bit. As shown in FIG. 10, the L2 switch 17a outputs, to a network port 17-2 (to the IP network 30), the IP packets imparted with the high-priority ToS bit value among the IP packets input by way of a plurality of user ports 17-1 (i.e., from the camera server 16).

For instance, in relation to a two-bit ToS value serving as a priority control bit, “00” is taken as a “non-priority” bit value, and “10” is taken as a “high-priority” bit value. An L2 switch 17a of the router 17 outputs, to a network port 17-2 in a prioritized manner, an IP packet given a ToS bit of “10,” which is a “high-priority” bit, among a plurality of the IP packets input by way of the user port 17-1.

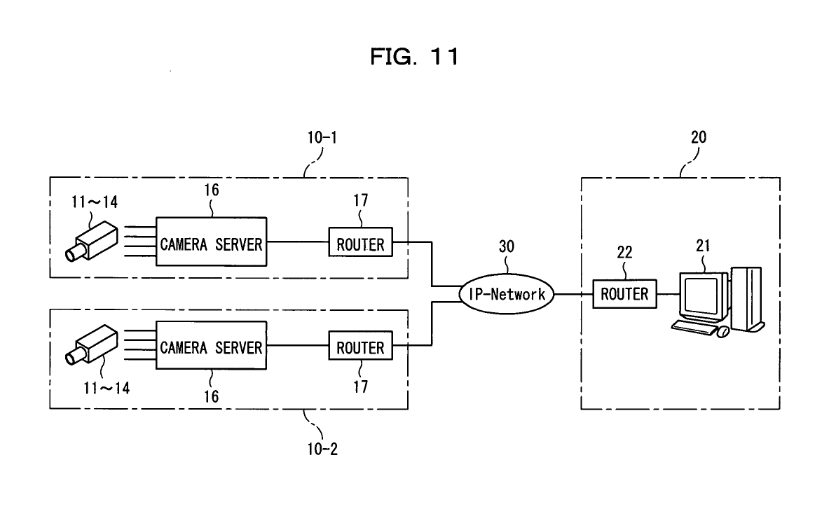

As shown in FIG. 11, for instance, when the monitoring station 20 monitors two monitored stations 10-1, 10-2 by way of the IP network 30 having a band of 100 Mbps or thereabouts, the camera server 16 assigned to the monitored stations 10-1, 10-2 merges the video data output from the imaging devices 11 to 14 in normal times where no status change arises in the monitored stations 10-1, 10-2. The thus-merged video data are transmitted as IP packets given the “non-priority” ToS bit.

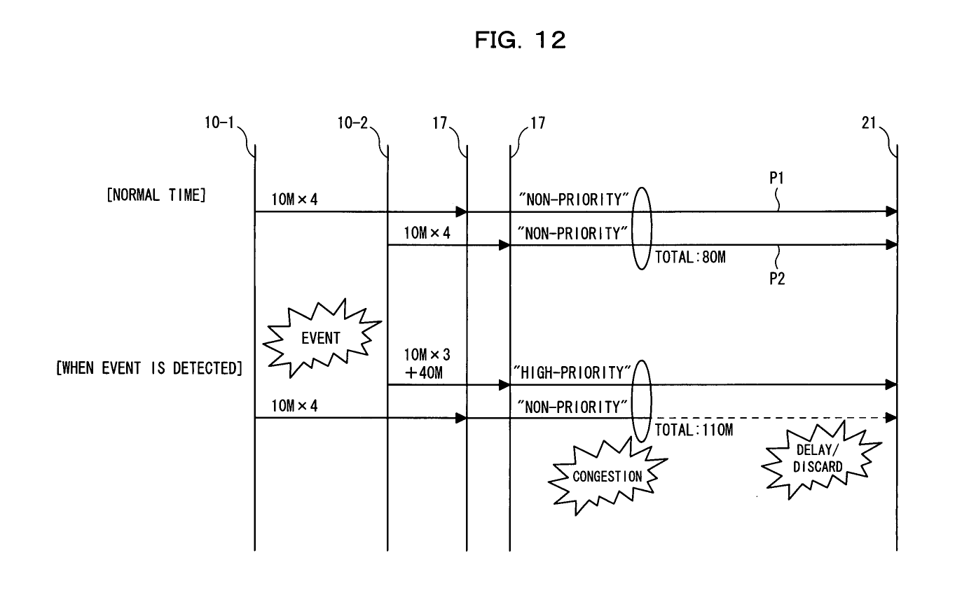

As can be seen from the sequence diagram shown in FIG. 12, the camera server 16 assigned to the respective monitored stations 10-1, 10-2 merges the video data of 10 Mbps output from the imaging devices 11 to 14 connected to the camera server 16, thereby transmitting video data P1, P2 having a total band of 40 Mbps. Accordingly, IP packets of the video data are transmitted over the IP network 30 through use of a band having a total of 80 Mbps.

When the camera server 16 of the monitored station 10-2 has detected the status change (event) E in the objects monitored by the imaging devices 11 to 14 connected to the camera server 16, the images output from the monitored station 10-1 are transmitted as IP packets assigned the “non-priority” ToS bit. In contrast, the images output from the monitored station 10-2 which has detected a status change are transmitted as IP packets assigned the “high-priority” ToS bit.

At this time, the image quality of the video data output from one of the imaging devices 11 to 14 (e.g., the imaging device 13) which has detected a status change can be enhanced by means of increasing the band from 10 Mbps to 40 Mbps through use of the settings of the stationary image generation section 41a effected by the image quality setting section 44b of the priority setting section 44f.

In this case, the IP packets which are assigned the “high-priority” ToS bit and output from the monitored station 10-2 use a band of 70 Mbps. Accordingly, the IP packets of the video data are transmitted through the IP network 30 by use of a total band of 110 Mbps, which is larger than the band (100 Mbps) of the IP network 30.

The video data output from the monitored station 10-1 are transmitted as the IP packets assigned the “non-priority” ToS bit. Therefore, discarding portions of the IP packets exceeding the band of the IP network 30 is also conceivable. However, the video data output from the monitored station 10-2 are transmitted as IP packets assigned the “high-priority” ToS bit. Hence, the packets can be transmitted without fail by means of switching action of the L2 switch 17a of the router 17.

Specifically, displaying of the “non-priority” packets, some of which are discarded, is considered to involve occurrence of a delay or a data loss, or the like. However, displaying of the “high-priority” packets is more important than displaying of the “non-priority” packets, and hence such a delay or a loss can be ignored.

Therefore, as a result of synergistic operation of the network priority setting section 44e and the priority data imparting section 43d, there is constituted a priority packet generation section which generates packets assigned priority processing data from the imaging data about the object of surveillance in which a status change is determined to have arisen in the status change detection sections 44a-1 to 44a-3.

[B-3] Description of a Modification in Which the Monitoring Station Provides a Display

As mentioned above, the IP packets which have been subjected to transmission processing performed by the priority transmission section 16b in the image compression encoding section 41 and the network processing section 43 are transmitted over the IP network 30 and received by the monitoring station 20.

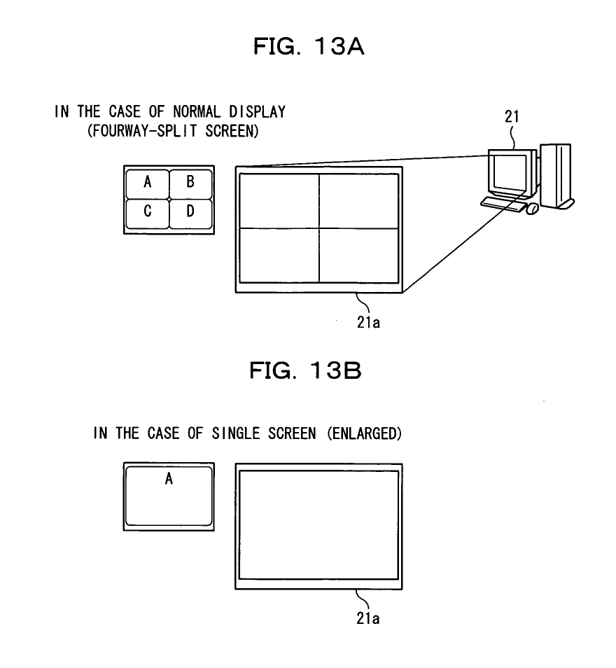

As shown in, e.g., FIG. 13A, the terminal device 21 of the monitoring station 20 displays the video data output from the monitored station 10 on a display 21a in the form of a plurality of split screens, thereby effecting uniform display (on four screen displays A to D) of the video data output from the respective imaging devices 11 to 14.

When a change in the status of any one of the imaging devices 11 to 14 of the monitored station 10 has been detected, the monitored station 10 transmits, in a prioritized manner, the video data output from the one of the imaging devices 11 to 14 in which the status change has been detected. The monitoring station 20 displays, in an enlarged manner on the display 21a, the video data transmitted with a high priority from the camera server 16. When a change in the status of any one of the imaging devices 11 to 14 of the monitored station 10 has been detected, only the video data output from the one of the imaging devices 11 to 14 is displayed so as to occupy the entire screen (i.e., in the form of one screen), as shown in, e.g., FIG. 13B.

In other words, as shown in FIG. 1, the terminal device 21 of the monitoring station has the function of a close-up display section. Upon receipt of the imaging data which have been transmitted from the camera server 16 in a prioritized manner and pertain to the object of surveillance—in which the status change is determined to have arisen by the determination section 16a—the close-up display control section performs control operation so as to display the video data in a close-up manner.

[B-4] Description of a Modification in Which the End Control Section Terminates Prioritized Transmission of Packets

As mentioned above, when the status change has been detected, the camera server 16 can transmit the video data in a prioritized manner by means of the priority transmission section 16b (see FIG. 1). Subsequently, the end control section 16c (see FIG. 1 and reference numeral 44g in FIGS. 3 through 5) can terminate prioritized transmission of video data in two modifications provided below.

[B-4-1] Description of a First Modification in Which the End Control Section Terminates Priority Transmission of Packets

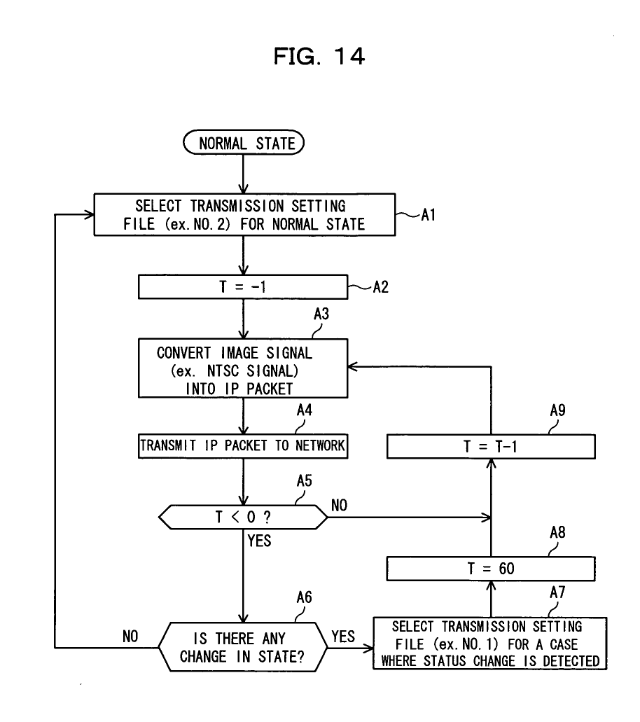

FIG. 14 is a flowchart for describing the first modification in which the end control section 44g (see FIGS. 3 through 5) terminates priority transmission. As shown in FIG. 14, the end control section 44g can automatically reset the transmission settings to those for normal times after lapse of a predetermined period of time (e.g., five minutes or after lapse of a time during which T=60 in FIG. 14 becomes T<0).

Specifically, in normal times, the priority setting section 44f (see FIGS. 3 through 5) extracts from the transmission setting pattern memory 47 a transmission setting file (e.g., a setting file of No. 2) for normal times (step A1); takes, as T=−1, an initial value of a variable T to be used for clocking a priority transmission time after occurrence of the status change (step A2); converts the video signals (i.e., the NTSC signals) output from the imaging devices 11 to 14 into the IP packets through processing of the image encoding compression section 41 and that of the network processing section 43 (step A3); and transmits the IP packets to the IP network 30 (step A4).

When, during the course of transmission of the IP packets in such normal times (a loop followed after steps A1 to A4, selection of YES in step A5, and selection of NO in step A6), a change has arisen in the status of the object of surveillance monitored by any one of the imaging devices 11 to 14 (a routine followed as a result of selection of YES in step A6), the priority setting section 44f extracts a transmission setting file for the case of detection of a status change (e.g., a setting file No.1) from the transmission setting pattern memory 47 and effects transmission settings of the image compression encoding section 41 and those of the network processing section 43 in accordance with the transmission setting file (step A7).

The image compression encoding section 41 and the network processing section 43, which have undergone transmission setting, transmit an input video signal to the IP network 30 after having converted the video signal into IP packets for priority transmission purpose. At this time, under the assumption that the variable T is taken as being equal to 60, the end control section 44g decrements T by one, thereby performing clocking operation (steps A8 and A9, step A3, and step A4).

Subsequently, the image compression encoding section 41 and the network processing section 43 cause the priority transmission section 16 to continue performing priority transmission which is to be effected at the time of detection of a status change, until the variable T managed by the end control section 44g becomes T<0 (a loop followed after selection of NO in step A5 and including steps A9, A3, and A4).

When the managed variable T has come to T<0, the end control section 44g can terminate the priority transmission. At this time, the end control section 44g can also terminate the priority transmission after the status change detection sections 44a-1 to 44a-3, which act as the determination section 16a, have determined elimination of the status change.

Specifically, when the status change detection sections 44a-1 to 44a-3, which act as the determination section 16a, detect elimination of the status change, the priority transmission operation performed by the priority transmission section 16b is returned to a normal video data transmission operation at that point in time (a routine followed after selection of YES in step A5 and selection of NO in step A6).

When the status change is determined not to have been eliminated (e.g., when the external sensor 15-3 determines that the door is left open or a like case), the end control section 16c causes the priority transmission section 16 to continue priority transmission while performing clocking operation by means of again taking T as 60, until the status change is eliminated (a routine followed after selection of YES in step A6).

When the signal which indicates a status change is output from any of the external sensors 15-1 to 15-4, the sensor having detected the status change, has disappeared, the sensor status change detection section 44a-1 (see FIG. 3) identifies elimination of the status change. In relation to an image in which a difference between frames is perceived and a status change is detected, the image status change detection section 44a-2 (see FIG. 4) identifies elimination of the status change when only a difference which is smaller than the preset threshold value is detected. Moreover, upon receipt of a change request cancellation command of the transmission settings requested by the monitoring station 20, the execution status change detection section 44a-3 (see FIG. 5) identifies elimination of the status change.

Therefore, the end control section 44g (16c) for performing end control according to the first embodiment has the function of a clocking section for clocking a time during which the priority transmission section 16b performs priority transmission, as well as the function of a first control section for terminating the priority transmission performed by the priority transmission section when the time—during which the priority transmission is performed—is determined to have exceeded a predetermined time by the clocking section.

[B-4-2] Description of a Second Modification for Terminating Priority Transmission of Packets by the End Control Section

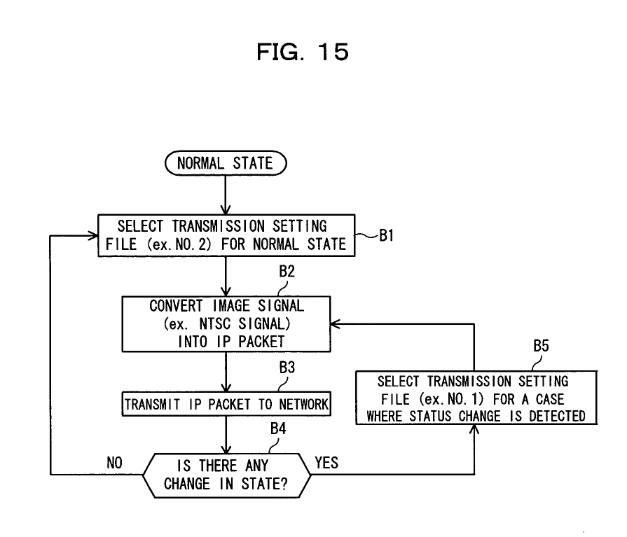

FIG. 15 is a flowchart for describing a second modification in which the end control section 44g (see FIGS. 3 to 5) terminates priority transmission of packets. Specifically, as shown in FIG. 15, the end control section 44g identifies elimination of the status change by mans of the status change detection sections 44a-1 to 44a-3, which act as the determination section 16a, as in the case of the first modification, and automatically resets the transmission settings to those for normal times.

Specifically, in normal times, priority setting section 44f (see FIGS. 3 through 5) extracts a transmission setting file for normal times (e.g., a setting file No. 2) from the transmission setting pattern memory 47 (step B1); converts the video signals (NTSC signals) output from the imaging devices 11 to 14 into the IP packets through processing of the image encoding compression section 41 and that of the network processing section 43; and transmits the IP packets to the IP network 30 (step B3).

When, during the course of transmission of the IP packets in such normal times (indicated by a loop followed after steps B1 to B3 and selection of NO in step B4), a change has arisen in the status of the object of surveillance monitored by any one of the imaging devices 11 to 14 (a routine followed as a result of selection of YES in step B4), the priority setting section 44f extracts from the transmission setting pattern memory 47 a transmission setting file for the case of detection of a status change (e.g., the setting file No. 1) and effects transmission settings of the image compression encoding section 41 and those of the network processing section 43 in accordance with the transmission setting file (step B5).

As mentioned above, the image compression encoding section 41 and the network processing section 43, which have undergone transmission setting, convert the input video signal into IP packets for priority transmission and send the IP packets to the IP network 30 (steps B2, B3).

Subsequently, the status change detection sections 44a-1 to 44a-3, which serve as the determination section 16a, terminate priority transmission after having determined elimination of the status. Further, when the status change detection sections 44a-1 to 44a-3, which serve as the determination section 16a, have detected elimination of the status change, the priority transmission operation performed by the priority transmission section 16b is returned to normal video data transmission operation (a routine followed after selection of NO in step B4 to step B1).

When the status change is determined not to have been eliminated (e.g., the external sensor 15-3 determines that the door has been left open or the like), the end control section 16c causes the priority transmission section 16b to continue priority transmission until the status change is eliminated (a routine followed after selection of YES in step B4).

Consequently, the status change detection sections 44a-1 to 44a-3, which serve as the determination section 16a, have the function of a status recovery determination section for determining whether or not the status change has been eliminated, in connection with the object of surveillance in which the status change is determined to have arisen. Moreover, the end control section 44g (16c) for performing end control operation of the second modification has the function of a second control section. Upon occurrence of the status change in the object of surveillance in which a status change is determined to have been eliminated by the status change detection sections 44a-1 to 44a-3, the second control section terminates the priority transmission performed by the image compression encoding section 41 and the network processing section 43.

[C] Description of Working-effect of an Imaging Data Transmission System of the Embodiment

As mentioned above, according to the embodiment, the camera server 16 can transmit to the monitoring station 20 the imaging data pertaining to the object of surveillance in which the status change is determined to have arisen by the determination section 16a, with a higher priority than that employed in the case of the imaging data pertaining to the objects of surveillance in which no status change is determined to have arisen, by means of the priority transmission section 16b. Hence, there is an advantage of the ability to reliably transmit the imaging data pertaining to an object of surveillance in which a status change is determined to have arisen, while realizing real-time remote surveillance of the object and realizing effective utilization of a network band.

Since the priority transmission section 16b can be constituted so as to transmit imaging data after enhancing image quality of imaging data, a display of the imaging data pertaining to an important object of surveillance in which a status change is determined to have arisen can be made sharper. Hence, there is an advantage of the monitoring station 20 being able to perform more accurate monitoring operation.

Moreover, the transmission image selection section 44c serving as an imaging data selection control section and the selection/merging section 41b can form an image frame to be transmitted from only an important object of surveillance in which a status change is determined to have arisen. Hence, there is an advantage of the ability to transmit only an important image at the time of surveillance by means of efficiently utilizing a band, thereby rendering network costs efficient.

By means of a combination of the function of enhancing image quality of the object of surveillance in which the status change is determined to have arisen and the function of the imaging data selection control section, the efficiency of band usage can be improved remarkably as compared with a case where there is previously prepared a network having the maximum band for the case of occurrence of a status change.

Moreover, by means of the network priority setting section 44e and the priority data imparting section 43d, which act as the priority packet generation section or the band reserving control section, the important object of surveillance in which the status change is determined to have arisen can be reliably transmitted while effectively utilizing the network band without consideration of a band to be used by the other camera server 16.

Specifically, under an assumption of a modification in which a transmission rate of images output from the other camera server 16 is decreased or data transmission is stopped when an event has arisen in a certain image, when an event arises in a certain image, the camera server having detected the event must control images of cameras connected to the camera server (i.e., must decrease a transmission rate or stop transmission of images) and inform another camera server of detection of the event. Therefore, procedures for exchanging a control signal between the camera servers or between the camera server and a monitoring station must be implemented. The greater the number of camera servers, the greater the number of bands used by the control signal.

In contrast, the present embodiment obviates a necessity for taking into consideration a band used by another camera server, and the only requirement is to solely control transmission packets of the image in which the event is detected, thereby obviating a necessity for exchanging a signal between the camera servers. Therefore, in comparison with the above-presumed modification, the present embodiment enables lessening of the influence of load and processing of the network on procedures.

[D] Others

In spite of the foregoing embodiment, the present invention can be carried out while being variously modified within the scope of gist of the invention.

For instance, in the present embodiment, the camera server 16 sequentially transmits stationary image frames. However, the present invention is not limited to this arrangement. For example, the present invention can also be configured to transmit video data which are obtained by merging motion picture data corresponding to video data captured by the imaging devices 11 to 14 and subjecting the thus-merged data to compression and encoding according to a scheme of, e.g., MPEG (Moving Picture Experts Group). In this case, upon implementation of the second modification of the determination section 16 detecting a status change, a difference between the frames is computed on the basis of the data output from the DCT/quantization section 41, thereby determining whether or not the status change is present on the basis of the resultantly-obtained computation result.

In the respective embodiments, the priority setting section 44f of the transmission setting processing section 44 comprises the image quality setting section 44b, the transmission image selection section 44c, the compression rate setting section 44d, and the network priority setting section 44e. According to the invention, setting operation is performed by means of providing any of the transmission image selection section 44c, the compression rate setting section 44d, and the network priority setting section 44e. As a result, transmission of the images output from at least one of the imaging devices 11 to 14 which has detected a status change can be made reliable. Needless to say, the reliability of communication of the image of the imaging device in which the status change has been detected is enhanced by means of an appropriate combination of the settings, or image quality and reliability are improved by means of a combination of the settings with settings of the image quality setting section 44b.

The imaging data server and the imaging data transmission system, both pertaining to the invention, can be manufactured by means of the foregoing embodiment.

1. An imaging data server which acquires a plurality of types of imaging data pertaining to a plurality of objects of surveillance and which transmits the acquired imaging data to a monitoring station over a network, the server comprising:
a determination section for determining whether or not a change has arisen in the status of each of said objects of surveillance pertaining to a plurality of types of said imaging data; and
a priority transmission section for transmitting, to said monitoring station, imaging data pertaining to an object of surveillance in which said status change is determined to have arisen by said determination section, with a higher priority than imaging data pertaining to an object of surveillance in which no status change is determined to have arisen.

2. The imaging data server according to claim 1, further comprising:
external sensors for detecting a change in the status of each of objects of surveillance, wherein
said determination section has a sensor data determination section for determining whether or not said status change has arisen, on the basis of detection data output from said external sensors.

3. The imaging data server according to claim 1, wherein
said determination section comprises
a frame difference computation section for computing a difference in frames of imaging data acquired for a plurality of said respective objects of surveillance; and
a frame difference determination section for determining whether or not said status change has arisen, on the basis of a result of computation of said frame difference computed by said frame difference computation section.

4. The imaging data server according to claim 1, wherein said determination section comprises:
a transmission environment setting receiving section for receiving settings of a transmission environment pertaining to specific imaging data output from said monitoring station; and
a priority requirement determination section which determines whether or not said status change has arisen on the basis of said transmission environment settings received by said transmission environment setting receiving section.

5. The imaging data server according to claim 1, wherein said priority transmission section comprises an image quality control transmission section for transmitting imaging data pertaining to said object of surveillance in which said status change is determined to have arisen by said determination section, after having enhanced image quality of said imaging data.

6. The imaging data server according to claim 2, wherein said priority transmission section comprises an image quality control transmission section which transmits imaging data pertaining to said object of surveillance in which said status change is determined to have arisen by said determination section, after having enhanced image quality of said imaging data.

7. The imaging data server according to claim 3, wherein said priority transmission section comprises an image quality control transmission section which transmits imaging data pertaining to said object of surveillance in which said status change is determined to have arisen by said determination section, after having enhanced image quality of said imaging data.

8. The imaging data server according to claim 4, wherein said priority transmission section comprises an image quality control transmission section which transmits imaging data pertaining to said object of surveillance in which said status change is determined to have arisen by said determination section, after having enhanced image quality of said imaging data.

9. The imaging data server according to claim 1, wherein said priority transmission section comprises a priority packet generation section for generating a packet imparted with priority processing data, from imaging data pertaining to said object of surveillance in which said status change is determined to have arisen by said determination section.

10. The imaging data server according to claim 1, wherein said priority transmission section comprises a band reserving control section which performs control operation for securing a band of said network over which are transmitted imaging data pertaining to said object of surveillance in which said status change is determined to have arisen by said determination section.

11. The imaging data server according to claim 1, wherein said priority transmission section comprises an imaging data selection transmission section which stops transmission of imaging data pertaining to an object of surveillance in which no status change is determined to have arisen by said determination section and which transmits imaging data pertaining to an object of surveillance in which said status change is determined to have arisen by said determination section.

12. The imaging data server according to claim 1, further comprising an end control section for terminating said priority transmission of said priority transmission section.

13. The imaging data server according to claim 12, wherein said end control section comprises
a clock section for clocking a time during which said priority transmission section performs said priority transmission; and
a first control section for terminating said priority transmission performed by said priority transmission section when said clock section determines that said time during which said priority transmission is being performed has exceeded a predetermined time.

14. The imaging data server according to claim 12, wherein said end control section comprises
a status recovery determination section for determining whether or not said change in the status of said object of surveillance in which said status change is determined to have arisen by said determination section has disappeared; and
a second control section for terminating said priority transmission performed by said priority transmission section when said status recovery determination section has determined that said change in the status of said object of surveillance, in which said status change is determined to have arisen, has disappeared.

15. An imaging data transmission system comprising:
a plurality of imaging devices for capturing images of objects of surveillance;
a monitoring station for receiving said images captured by said imaging devices for monitoring purpose; and
an imaging data server which acquires said imaging data captured by said respective imaging devices and which transmits said acquired imaging data to said monitoring station over a network, wherein
said imaging data server comprises
a determination section which determines whether or not a change has arisen in the status of an object of surveillance pertaining to said imaging data captured by said respective imaging devices; and
a priority transmission section for transmitting, to said monitoring station, imaging data pertaining to an object of surveillance in which said status change is determined to have arisen by said determination section, with a higher priority than imaging data pertaining to an object of surveillance in which no status change is determined to have arisen.

16. The imaging data transmission system according to claim 15, wherein said monitoring station has a close-up display control section which performs control operation for displaying said imaging data in a close-up manner upon receipt of said imaging data pertaining to said object of surveillance in which said status change is determined to have arisen by said determination section and having been transmitted from said imaging data server in a prioritized manner.
